(19) United States
(12) Patent Application Publication
(10) Pub. No.: US 2021/0101166 A1
(43) Pub. Date: Apr. 8, 2021

(54) System and Method for Preventing Graffiti Application on a Surface

(71) Applicant: John Cuellar, San Antonio, TX (US)

(72) Inventor: John Cuellar, San Antonio, TX (US)

(21) Appl. No.: 16/594,047

(22) Filed: Oct. 6, 2019

(51) Int. Cl. B05B 12/12; G08B 15/00; B05B 1/20

(52) U.S. Cl. CPC B05B 12/122; B05B 1/20; G08B 15/00

(57) ABSTRACT

A system and method for preventing graffiti application on a surface is described herein. The anti-graffiti device can comprise a motion detector, a transformer, and a sprinkler valve. The motion detector can be capable of producing a signal once movement is detected. The transformer can be connected to the motion detector through a plurality of wires. After receiving the signal the transformer can be capable of applying a voltage. The sprinkler valve can be connected to the transformer. The sprinkler valve can be mountable to a sprinkler system, wherein at the voltage received from the transformer the sprinkler valve can be capable of allowing flow of water from a water supply to a plurality of sprinklers.

### BACKGROUND

This disclosure relates to a system and method for preventing graffiti application on a surface.

Vandalism such as graffiti has been one of the problems faced by most property owners, public and/or private. Clean up cost for unauthorized drawing, writing, and/or painting on different properties such as walls, buildings, etc., can be time consuming and expensive. As such, methods have been developed to prevent painting on a surface. A popular method for preventing painting on a surface is through applying an anti-graffiti coating, such as sacrificial anti-graffiti or permanent anti-graffiti. A sacrificial anti-graffiti coating can allow the anti-graffiti coating be easily removed when the surface has been vandalized. This can leave the surface clean thus, a new coat of sacrificial anti-graffiti coating can be applied. Furthermore, a permanent anti-graffiti coating can prevent graffiti from adhering to a surface. This type of anti-graffiti can be more expensive than the sacrificial anti-graffiti coating. Once a surface with permanent anti-graffiti coating has been vandalized, the surface can be cleaned using a solvent leaving the coating and underlying surface undamaged. Method of using anti-graffiti coating can be effective in removing graffiti from the surface while still keeping the surface undamaged. However, these methods can be inconvenient and expensive since the owner still need to cleanup and/or repaint the property after it has been vandalized. Moreover, use of anti-graffiti coating or any special paints can contain chemicals that can be hazardous to the environment or individuals.

As such it would be useful to have an improved system and method for preventing graffiti application on a surface.

### SUMMARY

A system and method for preventing graffiti application on a surface is described herein. The anti-graffiti device can comprise a motion detector, a transformer, and a sprinkler valve. The motion detector can be capable of producing a signal once movement is detected. The transformer can be connected to the motion detector through a plurality of wires. After receiving the signal the transformer can be capable of applying a voltage. The sprinkler valve can be connected to the transformer. The sprinkler valve can be mountable to a sprinkler system, wherein at the voltage received from the transformer the sprinkler valve can be capable of allowing flow of water from a water supply to a plurality of sprinklers.

A method for preventing graffiti application on a surface is described herein. The method can comprise the steps of mounting an anti-graffiti device to a sprinkler system, actuating a sprinkler valve once a signal is produced from a motion detector, and spraying of water by a plurality of sprinklers to one or more surfaces. The anti-graffiti device can comprise the motion detector, a transformer, and the sprinkler valve. The motion detector can be capable of producing the signal once movement is detected. The transformer can be connected to the motion detector through a plurality of wires. After receiving the signal the transformer can be capable of applying a voltage. The sprinkler valve can be connected to the transformer. The sprinkler valve can be mountable to the sprinkler system, wherein at the voltage received from the transformer the sprinkler valve can be capable of allowing flow of water from a water supply to the plurality of sprinklers.

### BRIEF DESCRIPTION OF THE DRAWINGS

FIG. 1 illustrates an anti-graffiti system mounted on a sprinkler system.

FIG. 2 illustrates an embodiment of an anti-graffiti system.

FIG. 3 illustrates how an anti-graffiti system can attach to existing sprinkler valve.

FIG. 4 illustrates another embodiment of an anti-graffiti system.

FIG. 5 illustrates a side view of an anti-graffiti system.

FIG. 6 illustrates a schematic diagram of an anti-graffiti system.

FIG. 7 illustrates how an anti-sprinkler system can function.

### DETAILED DESCRIPTION

Described herein is a system and method for preventing graffiti application on a surface. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

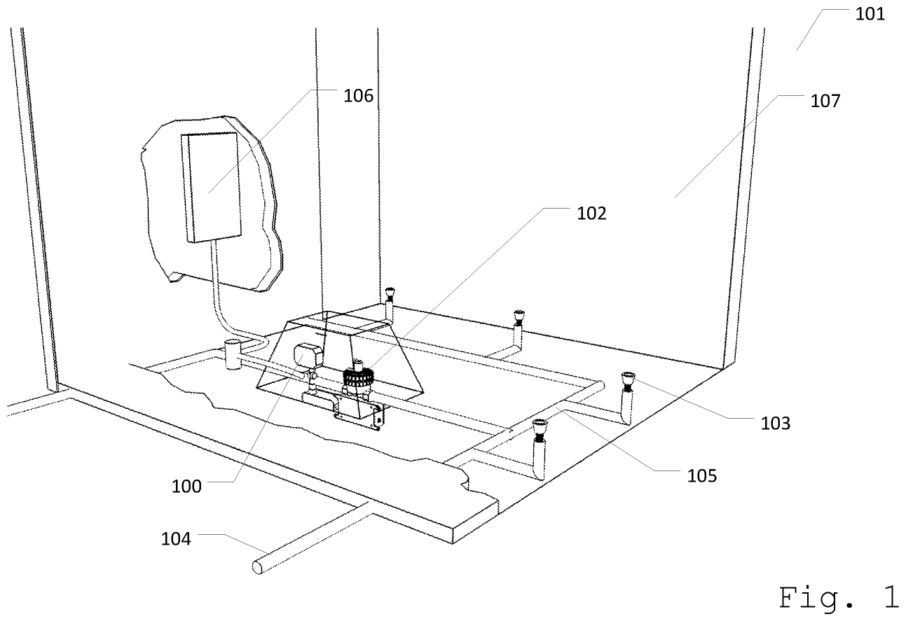

FIG. 1 illustrates an anti-graffiti system 100 mounted on a sprinkler system 101. In a one embodiment, sprinkler system 101 can be a lawn sprinkler system. Sprinkler system 101 can comprise one or more sprinkler valves 102, one or more sprinklers 103, and a water supply 104, and a plurality of pipes 105. Sprinkler system 101 can also comprise a controller 106 that connects to sprinkler valves 102. Controller 106 can control operations of sprinkler valves 102, such as when sprinkler valves 102 can turn on, and how long sprinkler valves 102 are kept turned on. Sprinkler system 101 can be capable of providing adequate pressure and flow rate of water supply from pipes 105 to sprinklers 103 through sprinkler valves 102. Each sprinkler 103 can be strategically placed such that the spray from each sprinkler 103 can reach one or more desired surfaces 107. Surfaces 107 can be any surface such as walls, which is to be protected from vandals. In one embodiment, anti-graffiti system 100 can be mounted on each sprinkler valves 102. Once triggered, anti-graffiti system 100 can allow flow of water from water supply 104 onto sprinklers 103. In one embodiment, water supply 104 can be the provision of water by public utilities, such as the water from a main water line. In another embodiment, water supply 104 can come from a water supply system that makes use of recycled water to conserve potable and/or drinking water.

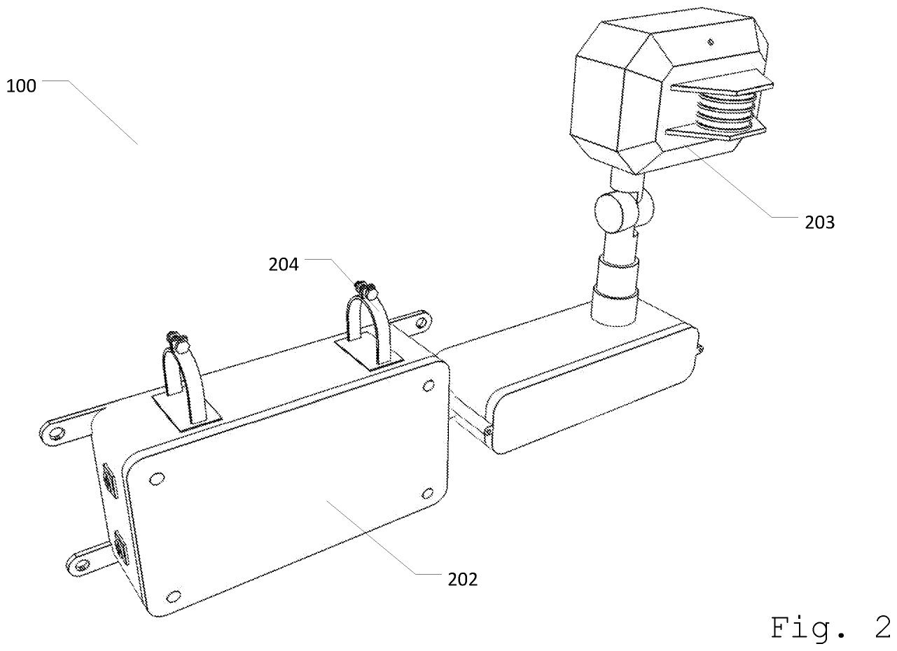

FIG. 2 illustrates an embodiment of anti-graffiti system 100. In this embodiment, anti-graffiti system 100 can be mounted with sprinkler valve 102 of existing sprinkler system 100. Anti-graffiti system 100 can comprise a transformer 202, and a motion detector 203. In one embodiment, transformer 202 can be unibody with motion detector 203. In such embodiment transformer 202 and motion detector 203 can be a single device. In this embodiment, anti-graffiti system 100 can further comprise of one o more fasteners 204. Fasteners 204 can attach permanently at one side of anti-graffiti system 100. Fasteners 204 can be any type of fastener capable of attaching anti-graffiti system 100 with existing sprinkler valve 102. Fasteners 204 can include but are not limited to pipe clamps, pipe hanger, nuts and bolts. In one embodiment, transformer 202 can further comprise a pair of screw terminals 205. Screw terminals 205 can attach at one side of transformer 202 and can electrically connect wires of sprinkler valve 102 with transformer 202.

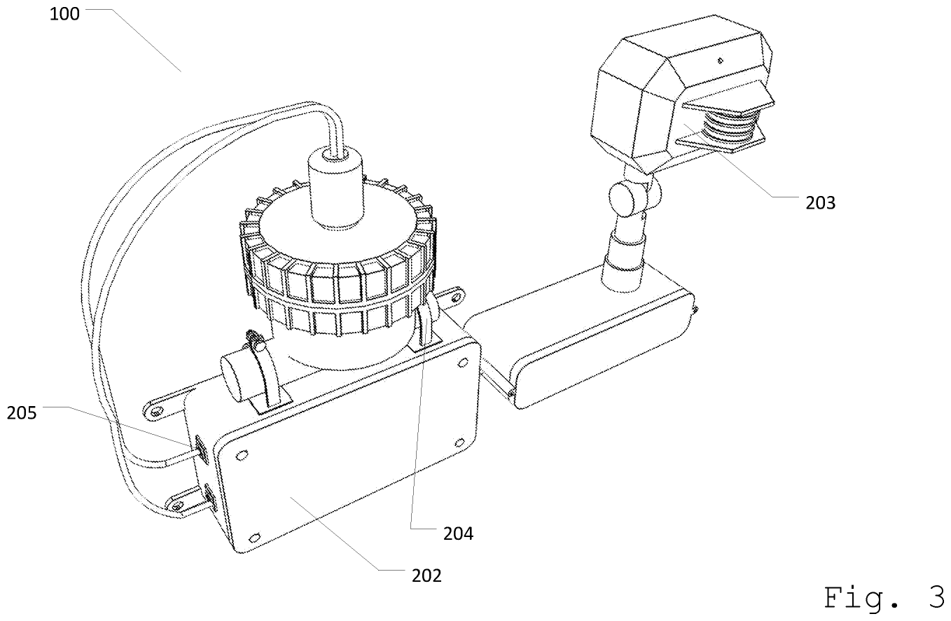

FIG. 3 illustrates how anti-graffiti system 100 can attach to existing sprinkler valve 102. Sprinkler valve 102 can comprise a body 301 that allows flow of water from water supply 104 to sprinklers 103. Body 301 can be a tube pipe at the opposite sides of sprinkler valve 102. Fasteners 204 on anti-graffiti system 100 can clamp onto body 301 of sprinkler valve 102. After mounting anti-graffiti system 100 to sprinkler valve 102, wires from the solenoid of sprinkler valve 102 can be attached to screw terminals 205 of transformer 202. In one embodiment, a protective device such as a grease cap, a water proof wire nuts, and/or electrical tape can secure and waterproof the connection between the wires and transformer 202.

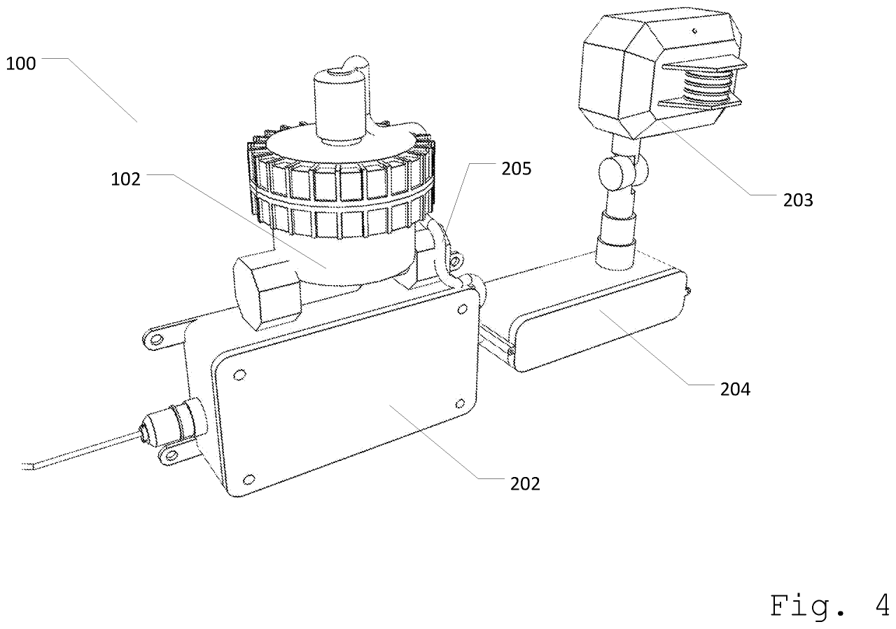

FIG. 4 illustrates another embodiment of anti-graffiti system 100. Anti-graffiti system 100 can function and/or be used as a replacement for sprinkler valve 102. In this embodiment, sprinkler valve 102, transformer 202, and motion detector 203 can be a single device. In one embodiment, transformer 202, and motion detector 203 can be unibody with sprinkler valve 102. In another embodiment, transformer 202, and motion detector 203 can attach to sprinkler valve 102 through methods that can include but are not limited to adhesion, fastening, and/or cementing. In one embodiment, sprinkler valve 102 can be a jar top sprinkler valve. Further, transformer 202 can attach at the bottom surface of sprinkler valve 102, while motion detector 203 can attach at one side of sprinkler valve 102. Further in a preferred embodiment, motion detector 203 can be connected with a ground fault circuit interrupter (GFCI) circuit. For purposes of this disclosure, GFCI circuit can shut off electric power when electric current flows along an unintended patch, such as through water.

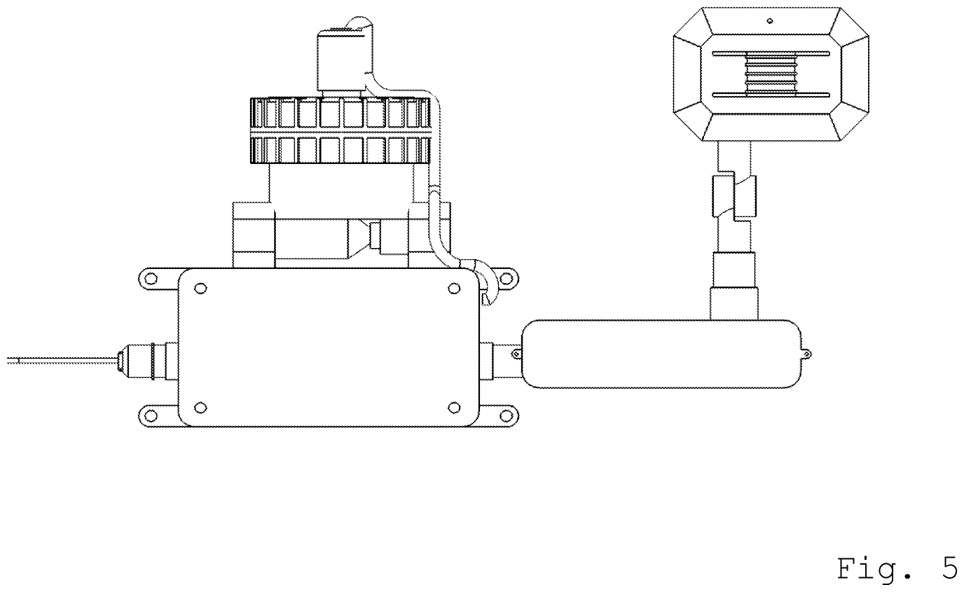

FIG. 5 illustrates a side view of anti-graffiti system 100. In this embodiment, the other end of wires that is connected to the solenoid of sprinkler valve 102 can be enclosed and connected within transformer 202.

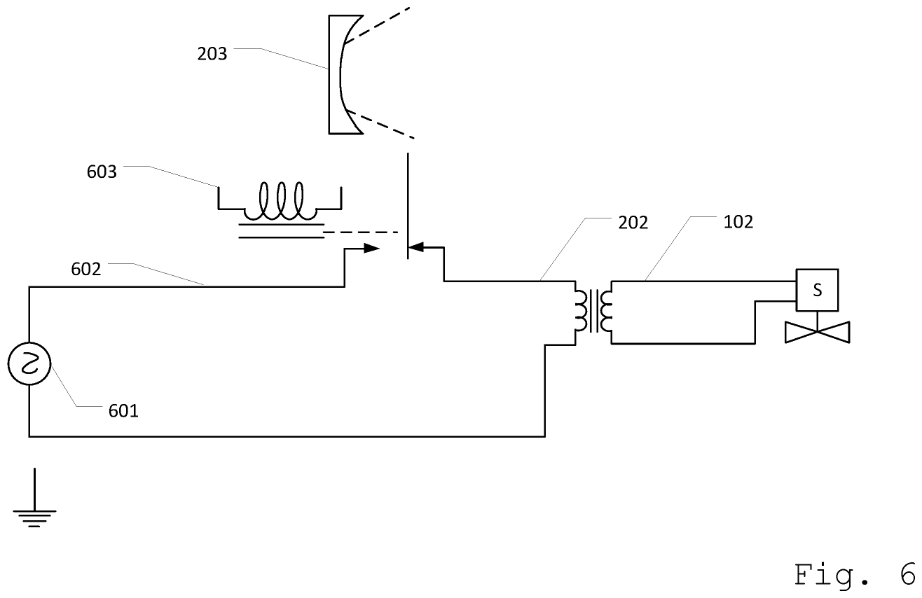

FIG. 6 illustrates a schematic diagram of anti-graffiti system 100. In one embodiment, anti-graffiti system 100 can connect directly to a power supply 601. Power supply 601 can be any electronic device capable of supplying electric energy to anti-graffiti system 100, such as a standard outlet or a circuit breaker. Transformer 202 can connect to motion detector 203 and sprinkler valve 102 through a plurality of wires 602. In one embodiment, transformer 202 can be an iron-cored transformer. Furthermore, transformer 202 and sprinkler valve 102 can connect with motion detector 102 through an inductor 603. In one embodiment, inductor 603 can be an iron core inductor. In this embodiment, when motion detector 102 is triggered electrical current passing through inductor 603 changes, which can induce the voltage across inductor 603. In such scenario, motion detector 203 can apply a certain voltage to sprinkler valve 102. In one embodiment, applied voltage can be 120 volts alternating current (AC). At a voltage received from motion detector, sprinkler valve 102 can open allowing water to flow from water supply 104 through sprinkler 103.

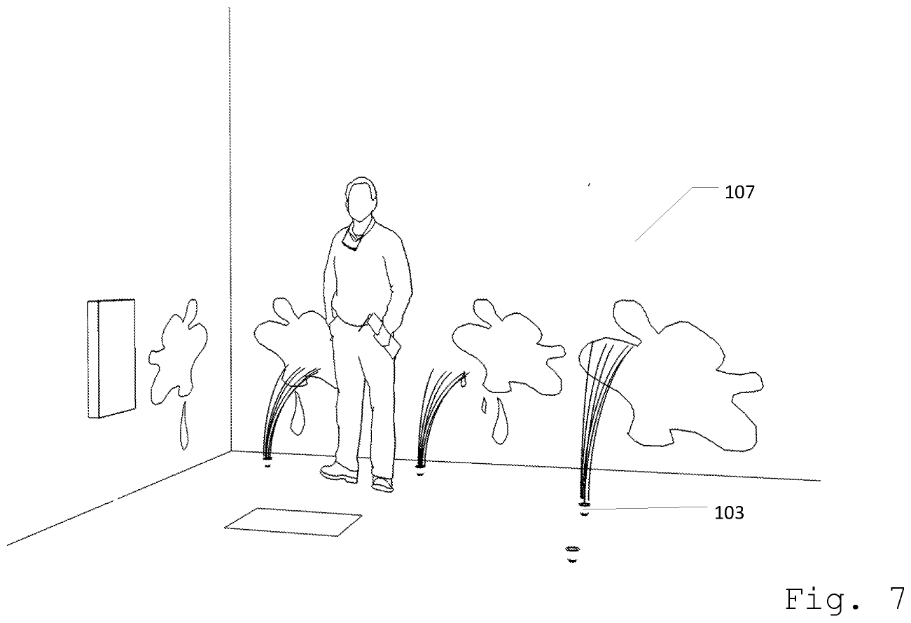

FIG. 7 illustrates how anti-sprinkler system 100 works. Sprinkler valves 102 can control conditions of liquid within sprinkler system 101 according to a signal received from motion detector 102. Based from the signal from motion detector 203, sprinkler valves 102 can operate to open and/or close thus, controlling flow, and/or pressure of water within sprinkler system 101. Pipes 205 can allow passage of liquid from water supply 104 to sprinklers 103.

As an example scenario, once motion detector 203 detects movement, motion detector 203 can send a signal to transformer 202. After receiving the signal, transformer 202 can apply a voltage from power supply 601 to sprinkler valve 102. The electric power applied to sprinkler valve 102 can actuate sprinkler valve 102 to open. This can allow water to flow from water supply 104 through sprinkler valve 102, which can allow sprinklers 103 to spray water onto surfaces 107. In such scenario, every time a vandal attempts to go near surfaces 107, motion detector 203 that detects the movement can send an electrical signal to transformer 202, which in turn can activate sprinkler system 101. With surfaces 107 being wet, vandals can find it difficult to paint surfaces 107. Once motion detector 203 does not sense any moving objects within range, motion detector 203 can stop sending an electrical signal to transformer 202. This can allow sprinkler valve 102 to close, preventing water to flow through sprinklers 103.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. An anti-graffiti device comprising:
a motion detector capable of producing a signal once movement is detected;
a transformer connected to said motion detector through a plurality of wires, after receiving said signal said transformer capable of applying a voltage; and
a sprinkler valve connected to said transformer, said sprinkler valve mountable to a sprinkler system, wherein at said voltage received from said transformer said sprinkler valve capable of allowing flow of water from a water supply to a plurality of sprinklers.

2. The anti-graffiti device of claim 1, further comprising one or more fasteners, said one or more fasteners capable of attaching said sprinkler valve with said transformer.

3. The anti-graffiti device of claim 1, wherein said sprinkler valve can be a unibody with said transformer.

4. The anti-graffiti device of claim 1, wherein said transformer and said sprinkler valve connects with said motion detector through an inductor, said inductor capable of inducing said voltage from said transformer.

5. The anti-graffiti device of claim 4, wherein the inductor can be an iron core inductor.

6. The anti-graffiti device of claim 1, wherein said transformer can be an iron cored transformer.

7. The anti-graffiti device of claim 1 wherein said applied voltage can be 120 volts.

8. A method for preventing graffiti application on a surface comprising the steps of:
mounting an anti-graffiti device to a sprinkler system said anti-graffiti device comprising:
a motion detector capable of producing a signal once movement is detected;
a transformer connected to said motion detector through a plurality of wires, after receiving said signal, said transformer capable of applying a voltage; and
a sprinkler valve connected to said transformer, said sprinkler valve mountable to a sprinkler system, wherein at said voltage received from said transformer, said sprinkler valve capable of allowing flow of water from a water supply to a plurality of sprinklers;
actuating said sprinkler valve once said signal is produced from said motion detector; and
spraying of water by said plurality of sprinklers to one or more surfaces.

9. The method of claim 8, prior to actuating step of said sprinkler valve, triggering said motion detector by a moving object.

10. The method of claim 8, wherein said anti-graffiti device further comprising one or more fasteners, said one or more fasteners capable of attaching said sprinkler valve with said transformer.

11. The method of claim 8, wherein said sprinkler valve can be a unibody with said transformer.

12. The method of claim 8, wherein said transformer and said sprinkler valve connects with said motion detector through an inductor, said inductor capable of inducing said voltage from said transformer.

13. The method of claim 12, wherein the inductor can be an iron core inductor.

14. The method of claim 8, wherein said transformer can be an iron cored transformer.

15. The method of claim 8, wherein said voltage applied can be 120 volts.
